(19) United States
(12) Patent Application Publication
(10) Pub. No.: US 2023/0194079 A1
(43) Pub. Date: Jun. 22, 2023

(54) APPARATUS, BURNER AND METHOD FOR THE FIRING OF CERAMIC ARTICLES

(71) Applicant: SACMI FORNI & FILTER S.P.A., IMOLA (IT)

(72) Inventor: Alberto TORO, IMOLA (IT)

(21) Appl. No.: 17/998,565

(22) PCT Filed: May 12, 2021
(86) PCT No.: PCT/IB2021/054056

§ 371 Date: Nov. 11, 2022

(30) Foreign Application Priority Data
May 12, 2020 (IT) 102020000010738
Jan. 15, 2021 (IT) 102021000000695

(51) Int. Cl. F23D 14/02; F23D 14/48; F27B 3/20; F27B 9/36; F27D 99/00

(52) U.S. Cl. CPC F23D 14/02; F23D 14/48; F27B 3/205; F27B 9/36; F27D 99/0033

(57) ABSTRACT

A burner for the firing of ceramic articles (T) which can be installed in an industrial kiln and comprising a mixing body, a first tubular discharge element, which is configured to be passed through by a fluid (F) flowing out of the mixing body, at least one second tubular discharge element and a suction element, which is configured to bring at least part of the gases (G, G′) present inside the firing chamber into the second tubular discharge element and is provided with one or more openings arranged between the first and the second tubular discharge elements. The mixing body comprises a multi-stage combustion head arranged at least partially inside the first tubular discharge element.

### CROSS REFERENCE TO RELATED APPLICATIONS

This patent application claims priority from Italian patent application no. 102020000010738 filed on Dec. 05, 2020 and Italian patent application no. 102021000000695 filed on 1May 01, 2021, the entire disclosure of which is incorporated herein by reference.

### TECHNICAL FIELD

The present invention concerns an apparatus and a burner for the firing of ceramic articles. In particular, the present invention is advantageously but not exclusively applied in the firing of ceramic articles to obtain tiles, to which the following description will explicitly refer without loss of generality.

### BACKGROUND OF THE INVENTION

The firing of ceramic articles to obtain tiles is generally carried out in tunnel kilns, delimited by two opposite walls and a roof. These kilns are usually heated by two sets of burners, each arranged on one side of the tunnel.

Typically, the methane gas-operated burners are located on the lateral walls of the tunnel on several levels and face the opposite wall.

The firing cycle of the ceramic articles is designed with great precision and entails: heating of the ceramic articles at the kiln entrance, residence of said articles inside the firing chamber at a predefined temperature and controlled cooling prior to reaching the kiln exit.

Usually, the ceramic articles are transported on a large conveyor consisting of a set of ceramic rollers. Consequently, it is important to guarantee that the temperature inside the firing chamber is uniform throughout the width of the kiln.

For this purpose, different types of industrial burners have been developed, and different arrangements of the burners inside complex apparatus, to obtain an increasingly constant temperature inside the firing chamber.

However, especially in very wide tunnel kilns, non-uniform distribution of the temperature generally occurs in the different longitudinal sections, with local temperature peaks determined according to the position of the burners. In particular, in many cases temperatures are higher in the centre of the tunnel and lower near the lateral walls.

This non-uniform temperature inevitably results in firing defects in the ceramic articles travelling near the walls of the tunnel. In particular, the defects can be both dimensional and shape defects, such as lack of planarity. This results in an increase in the number of discarded articles.

Usually, this temperature difference, between the centre of the kiln and the areas near the lateral walls, is due to the fact that the fumes circulating inside the firing chamber slow down near the walls, the turbulence of said fumes is reduced and consequently also the heat exchange coefficient.

In addition, as previously said, the ceramic burners of a known type are substantially supplied with fossil fuels (methane, LPG) which although on the one hand allow reduction in the emissions of NOx through normal combustion, on the other entail an anti-ecological use of non-renewable resources.

The document EP3155320 describes a burner for an industrial kiln, which can be installed in a kiln comprising at least one firing chamber and comprising a main tubular body provided with at least one first port for the inlet of a fuel and at least one second port for the inlet of the oxidizer, and with an end nozzle provided with an outlet facing the firing chamber, and elements for triggering combustion of the fuel-oxidizer mixture. The burner further comprises at least one duct, obtained between a second tubular element and the wall of the kiln, adapted to withdraw a portion of the gases present inside the firing chamber and convey them to the outlet of the end nozzle.

The document EP1217297 describes a burner for a gas turbine comprising a conical premixer.

The object of the present invention is to provide an apparatus, a burner and a method which overcome, at least partially, the drawbacks of the known art and at the same time are easy and inexpensive to produce.

### SUMMARY

In accordance with the present invention, a burner, an apparatus and a method are provided for the firing of ceramic articles as claimed in the following independent claims and, preferably, in any one of the claims depending directly or indirectly on the independent claims.

The claims describe preferred embodiments of the present invention forming an integral part of the present description.

### BRIEF DESCRIPTION OF THE DRAWINGS

The present invention will now be described with reference to the attached drawings, which illustrate some non-limiting embodiment examples thereof, in which:

FIG. 1 is a front view in section of a first embodiment of an apparatus according to the present invention;

FIG. 2 is a schematic plan view of a section of a second embodiment of an apparatus in accordance with the present invention;

FIG. 3 is a schematic perspective view of part of the apparatus of FIG. 1 comprising a burner in accordance with the present invention;

FIGS. 4 and 4a are front views in section of two different embodiments of the part of FIG. 3;

FIGS. 5 and 5a are front views in section of two different embodiments of a part of the apparatus of FIG. 2 comprising a further burner in accordance with the present invention;

FIGS. 6 and 6a are perspective schematic views of a part of the burner of FIGS. 4 and 4a respectively;

FIGS. 7 and 7a are views in longitudinal section and in detail of the burner of the part of FIGS. 6 and 6a respectively;

FIGS. 8 and 8a are front views in section of a combustion head of the burner of FIGS. 6 and 6a respectively;

FIGS. 9 and 10 are two front views in section of part of the combustion head of FIGS. 8 and 8a;

FIG. 11 is a perspective schematic view of a part of a burner in accordance with the present invention;

FIG. 12 is a lateral view in section of a part of the discharge body of FIG. 11; and

FIGS. 13 and 13a are two graphs that illustrate the temperature variation according to the distance from a wall of the kiln (the distance is shown on the X axis and the temperature on the Y axis).

### DETAILED DISCLOSURE

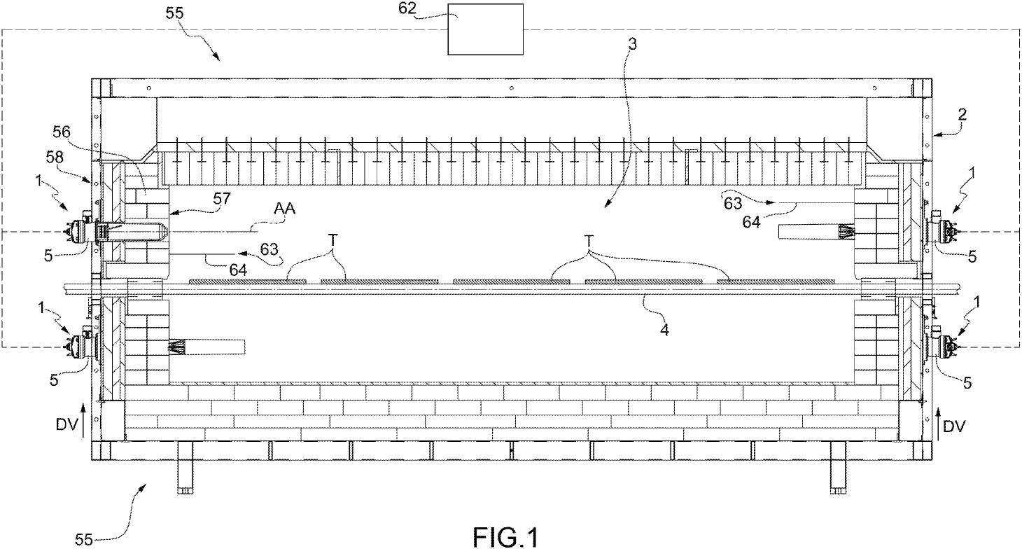

In FIG. 1, the number 1 indicates overall a burner for firing ceramic articles T in accordance with a first aspect of the present invention.

The burner 1 can be preferably but not necessarily installed in an industrial kiln 2, in particular a tunnel kiln, comprising a firing chamber 3.

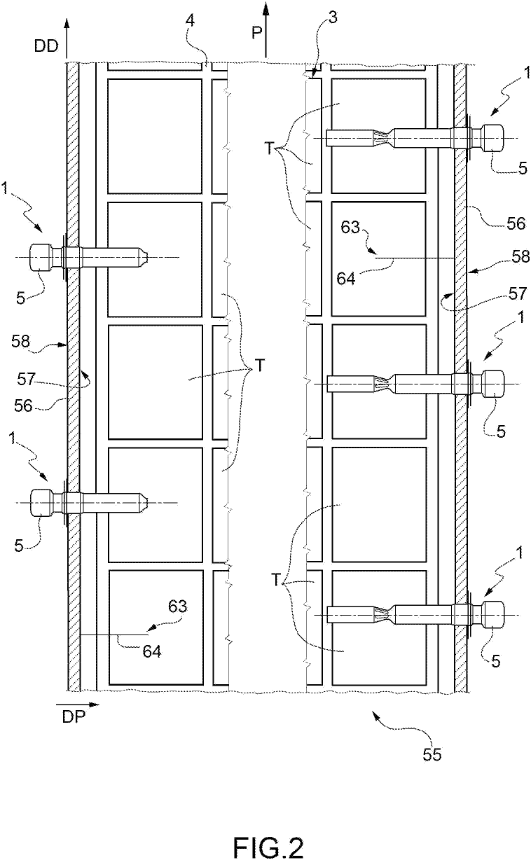

In particular, as illustrated in FIGS. 1 and 2, the ceramic articles T are moved by a transport system 4 along a conveying path P.

More precisely, the ceramic articles T are any type of ceramic article requiring at least one firing in a kiln.

In the non-limiting embodiment of FIGS. 1 and 2, the transport system 4 comprises a conveyor belt, on which the green ceramic articles T to be fired are arranged, preferably in an orderly manner.

According to some non-limiting embodiments not illustrated, the transport system 4 comprises a plurality of ceramic rollers (if necessary, also moved at different speeds to differentiate firing of the articles).

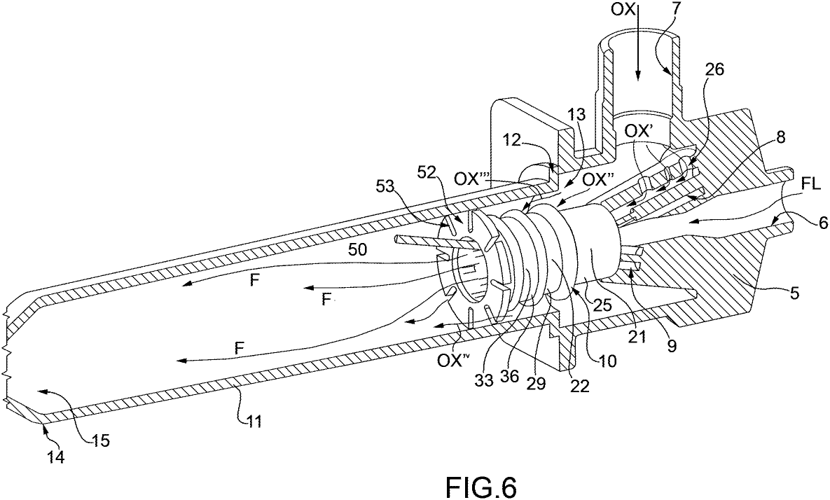

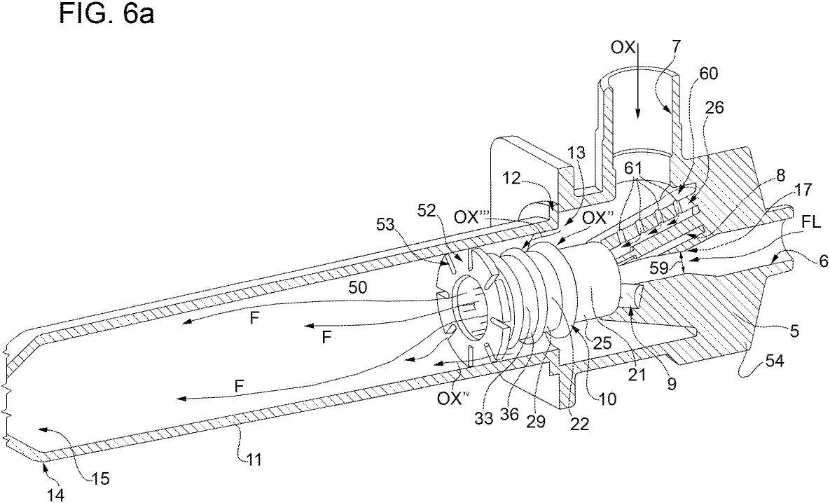

As illustrated in FIGS. 1 to 6a, the burner 1 comprises a mixing body 5, which in turn comprises a duct 6 to supply a fuel FL preferably comprising a percentage of hydrogen, an oxidizer supply duct 7, a trigger device 8 to start a combustion and a flame detection device 9. The burner further comprises a combustion head 10. In other words, the mixing body 5 is the part of the burner necessary for generating the mixture of air and gas which (following a trigger so as to obtain a flame) will fire the ceramic articles T inside the kiln 2. In particular, the fuel introduced by means of the fuel supply duct 6 is substantially methane gas, while the oxidizer introduced by means of the oxidizer supply duct 7 is substantially ambient air (with approximately, for example, 21% of oxygen).

The burner 1 further comprises a tubular discharge element 11, which is adapted to (configured to) be passed through by a fluid F flowing out of the mixing body 5 (formed of the mixture of fuel and oxidizer and/or any combustion thereof) and is provided with an end 12 having an opening 13, inside which at least a part of the mixing body 5 (in particular of the combustion head 10) is inserted, and an end 14 opposite the end 12 and having an opening 15.

According to some non-limiting embodiments, the mixing body 5 is coupled with the tubular discharge element 11 by means of fastening elements.

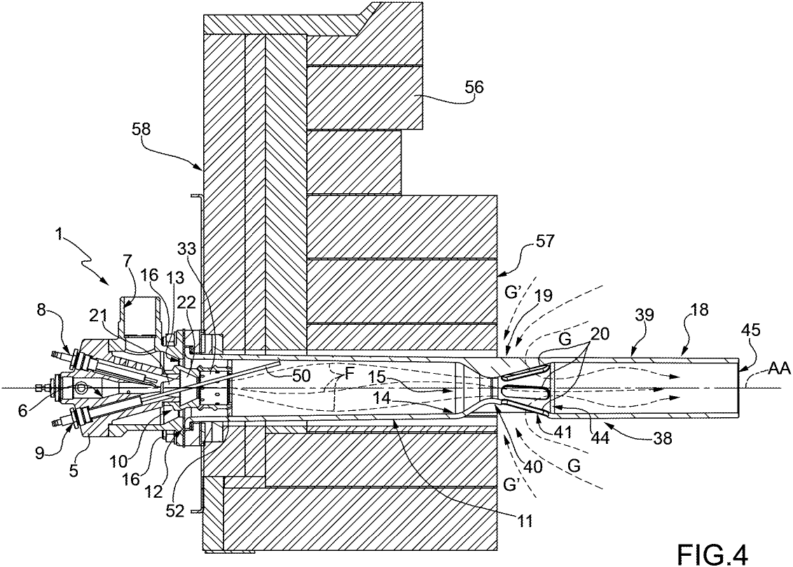

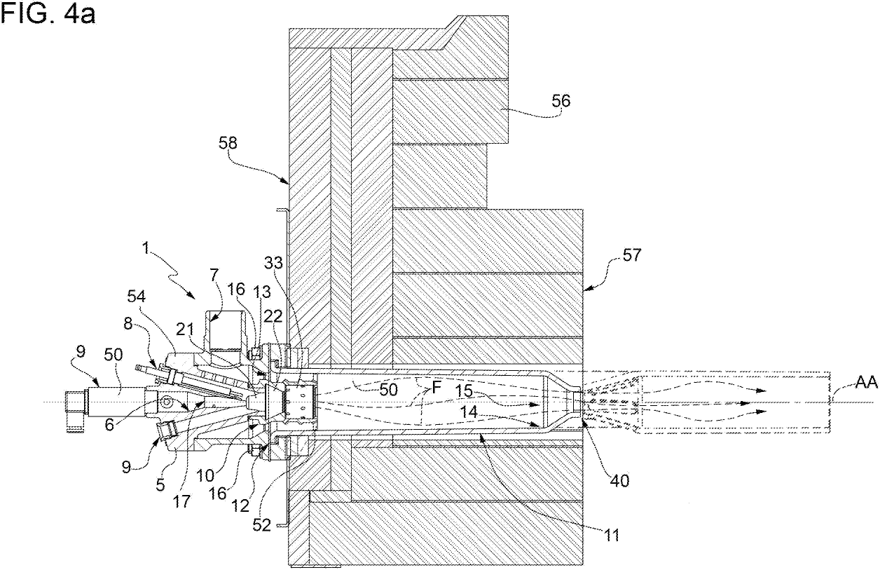

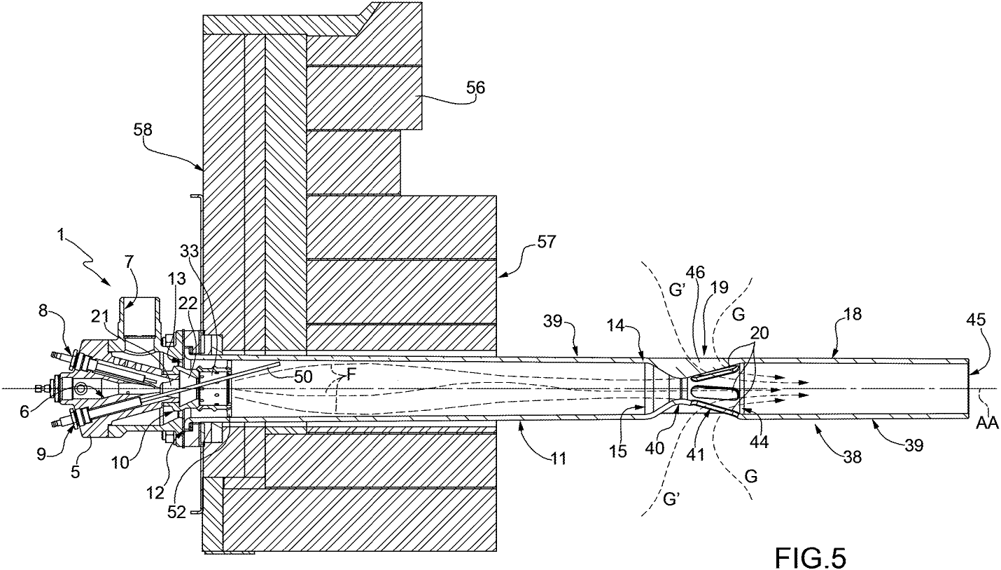

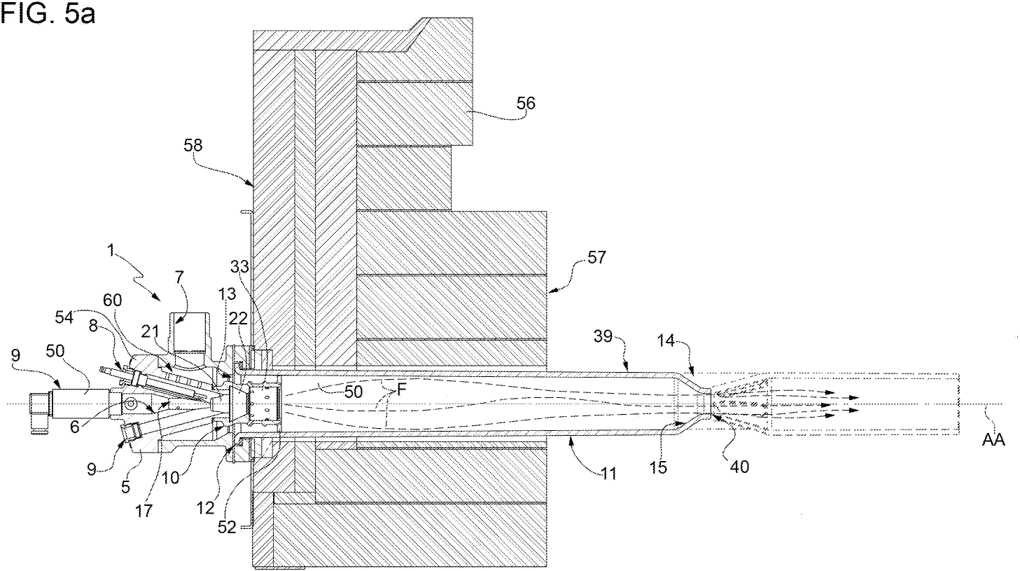

Advantageously but not necessarily, as in the embodiment illustrated in FIGS. 4, 4a and 5, 5a, the fastening elements are bolts 16.

In the non-limiting embodiment illustrated in FIGS. 4, 4a and 5, 5a, the mixing body 5 is inserted partly inside the discharge element 11 and is partly arranged outside the kiln 2. In particular, in the embodiment of FIG. 4 the discharge element 11 is inserted inside a lateral wall 56 of the tunnel kiln 2. More precisely, the discharge element 11 extends completely inside the lateral wall 56.

In the non-limiting embodiment of FIGS. 5, 5a, on the other hand, the discharge element 11 extends throughout the length of the lateral wall 56 partly entering also the firing chamber 3 of the kiln 2.

Advantageously but not necessarily, the burner 1 comprises a tubular discharge element 18 (illustrated, for example, by a broken line in FIGS. 4a and 5a) which extends from the end 14 of the element 11 in a direction opposite to the end 12, namely towards (more precisely the inside of) the firing chamber 3. In other words, the discharge element 18 is arranged on the opposite side of the discharge element 11 with respect to the mixing body 5.

In some non-limiting cases, the burner 1 comprises a suction element 19 which is adapted to (configured to) bring at least part of the gases G, G′ present outside the burner 1, in particular outside the discharge element 11 and/or the discharge element 18 (more precisely inside the firing chamber 3), into the tubular discharge element 18 and is provided with a plurality of openings 20 arranged between the element 11 and the tubular discharge element 18.

Advantageously but not necessarily, and as illustrated in the non-limiting embodiments of FIGS. 4, 4a and 5, 5a, the tubular discharge element 14 is (completely) entirely inside the firing chamber 3 and, for example, is coaxial with the tubular discharge element 11. In other words, the longitudinal axis of symmetry AA of the tubular discharge element 18 coincides with the longitudinal axis of symmetry AA of the tubular discharge element 11.

Advantageously and in a completely different manner from the standards used in the ceramics market, the combustion head 10 is a multi-stage combustion head, namely adapted to (configured to) split the formation of the flame into different stages. In this way it is possible to use the air staging technique to increase the flame speed to over 160 m/s, in particular to over 180 m/s, more precisely up to approximately 200 m/s. In fact, the term “highspeed” indicates, specifically with reference to burners, a flame speed higher than or equal to 150 m/s.

Advantageously but not necessarily, the combustion head 10 is mounted at least partially inside the tubular discharge element 11 so as to be coaxial with it along the longitudinal axis of symmetry AA of the burner 1.

As illustrated in the non-limiting embodiments of FIGS. 4 to 10, advantageously, the multi-stage combustion head 10 comprises (at least) one combustion chamber 21, which is adapted to (configured to) generate a first combustion phase of the flame (in particular to generate the so-called flame “root”), and (at least) one combustion chamber 22, communicating with the combustion chamber 21 and adapted to (configured to) generate a second flame combustion phase at the outlet of the combustion chamber 21. In particular, the combustion chambers 21 and 22 are configured to convey the flame at high speed inside the tubular discharge element 11 towards the end 14 and in particular through the suction element 19 towards the tubular discharge element 18.

Advantageously but not necessarily, and as illustrated in the non-limiting embodiments of FIGS. 4 to 8a, the supply duct 6 of the fuel FL comprises a nozzle 17 for introduction of the fuel FL towards the combustion chamber 21. The nozzle 17 has an axial hole 59 with a diameter smaller than 20 mm, in particular smaller than 15 mm, more in particular smaller than or equal to 13.5 mm. In this way, it is possible to increase the above-mentioned percentage of hydrogen in the fuel FL. In particular, the hydrogen determines a much greater backfire than the methane (or LPG) and it has surprisingly been noted that by increasing the supply speed of the fuel FL, the backfire can be appropriately countered, allowing adequate control thereof and at the same time injecting more fluid F into the firing chamber 3.

Advantageously but not necessarily, the nozzle 7 for introduction of the fuel FL is obtained in one piece on a breech 54 (in particular made of aluminium) of the burner 1.

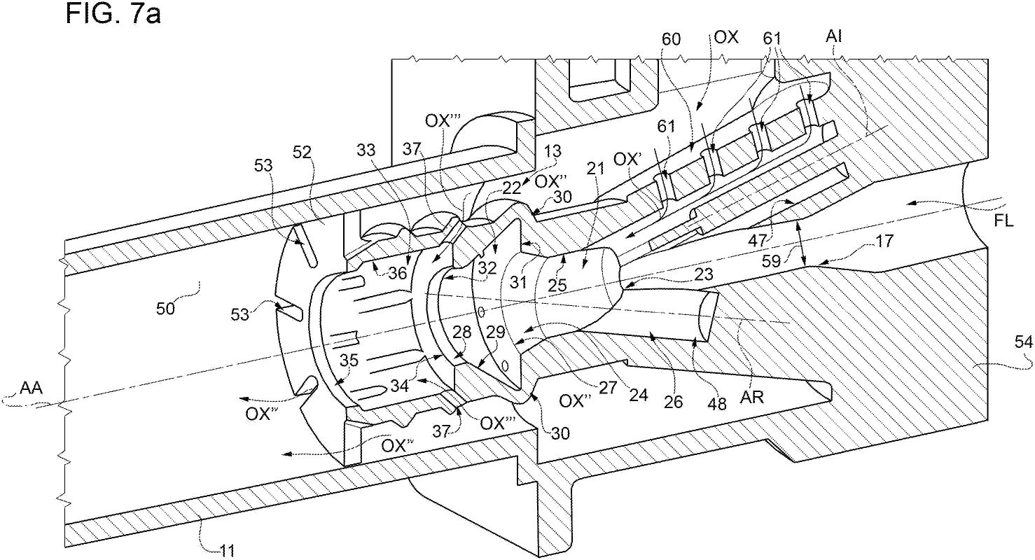

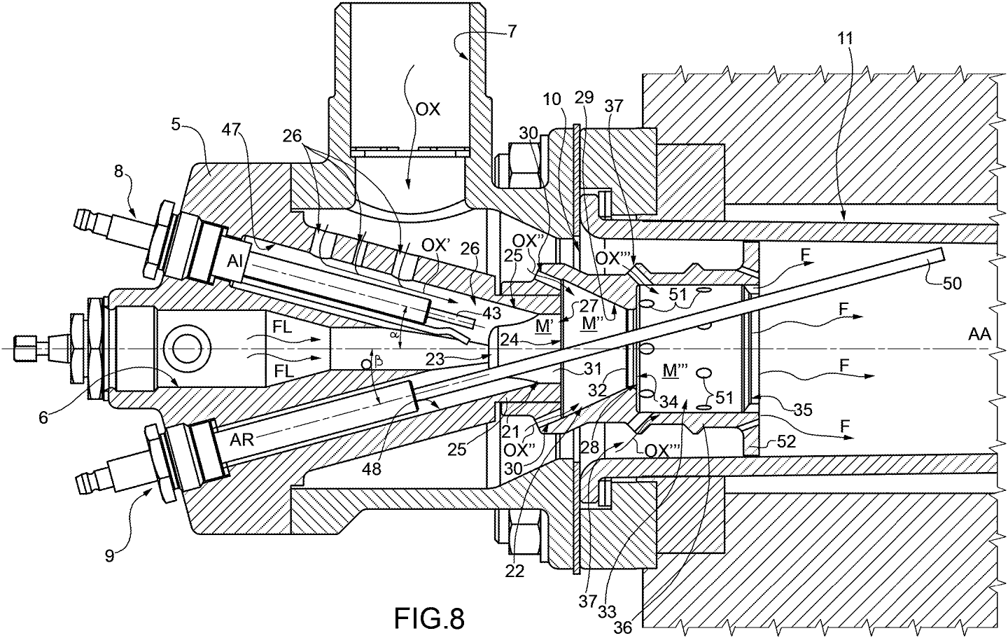

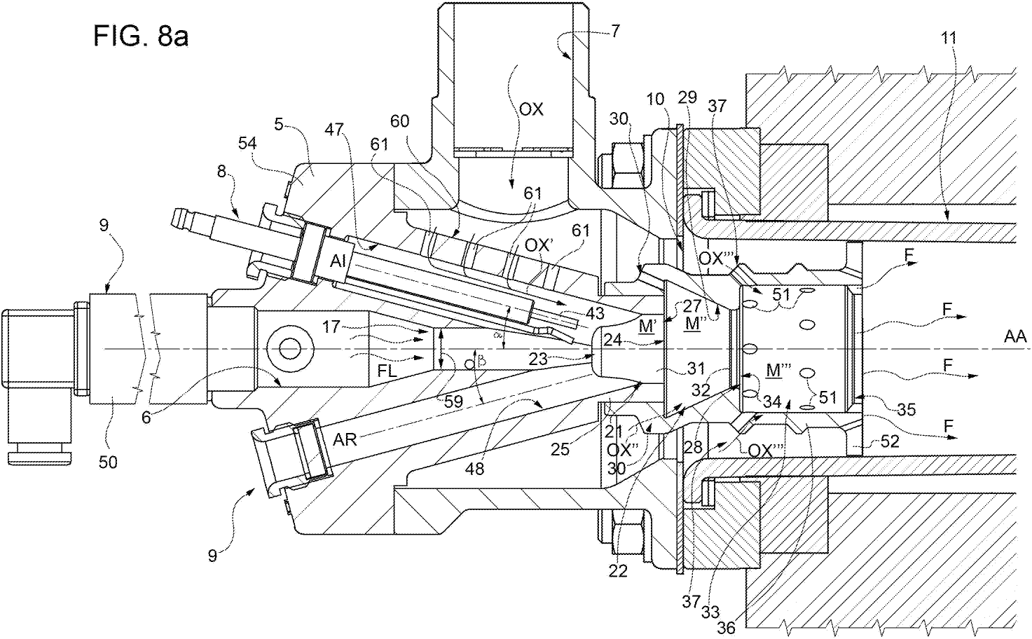

In the non-limiting embodiment of FIG. 8, in which a section of the multi-stage combustion head 10 is illustrated in detail, the combustion chamber 21 comprises at least one inlet opening 23 and an outlet opening 24 (more precisely arranged on opposite sides of the combustion chamber 21).

In particular, the inlet opening 23 is adapted to (configured to) be communicating with the fuel supply duct 6 and to receive a volumetric, more precisely variable, flow rate of said fuel. The outlet opening 24 faces the tubular discharge element 18 (or the firing chamber 3).

In some non-limiting cases, like the one illustrated in the embodiment of FIG. 8, the combustion chamber 21 and the combustion chamber 22 are coaxial with each other and arranged along the longitudinal axis AA of the burner 1.

Advantageously but not necessarily, the combustion chamber 21 also comprises a lateral wall 25, in particular cylindrical and/or frusto-conical (or having a complex shape), provided with one or more oxidizer supply channels 26 configured to convey a part OX′ of the oxidizer OX into the combustion chamber, generating an oxidizer-fuel mixture M′. In particular, the supply channels 26 of the oxidizer OX are configured to convey (direct) the part OX′ of the oxidizer OX to the trigger device 8 (and/or the flame detection device 9). This facilitates ignition of the burner at high capacities. More precisely, the supply channels 26 of the oxidizer OX have different diameters. Advantageously but not necessarily, the supply channels 26 of the oxidizer OX are configured to introduce the part OX′ of the oxidizer OX into the combustion chamber 21 with a speed having at least one component transverse to the axis of symmetry AA of the burner (along which the fuel FL is injected).

Advantageously but not necessarily, along the supply duct 7 of the oxidizer OX towards the combustion chamber 21 a distribution element 60 is arranged for distributing the oxidizer OX provided with a plurality of through openings 61 to split the oxidizer OX flowing into the combustion chamber 21, in particular through the oxidizer supply channels 26. More precisely, the openings 61 have a width of less than 5 mm, in particular less than 4 mm, preferably less than or equal to 3.5 mm. In this way, especially in the case of a particularly high percentage of hydrogen in the fuel FL, it is possible to obtain greater stability of the flame at minimum burner powers. In particular, it is thus possible to distribute in a more gradual uniform way the part OX′ of the oxidizer OX, so as to divert less the flow of the fuel FL at the minimum flow rates in the presence of holes with larger dimensions.

In particular, the distribution element 60 comprises at least three, in particular at least four, through openings 61 which, in particular, are circular holes. More in particular, the through holes 61 are equal to one another and are distributed on the distribution element along at least one direction parallel to the longitudinal axis AA of the burner 1. In detail, without limitation, the through openings 61 are arranged exclusively on the side of the duct 7.

Advantageously but not necessarily, the combustion chamber 22 comprises an inlet opening 27 and an outlet opening 28 opposite each other. The inlet opening 27 is configured to be communicating with the outlet opening 24 and to receive the oxidizer-fuel mixture M′. The outlet opening 28 faces the tubular discharge element 18 (or the firing chamber 3).

In some non-limiting cases, like the one illustrated in the embodiment of FIG. 8, the combustion chamber 22 also comprises a lateral wall 29 having a substantially circular transverse section; in particular, the transverse section of the lateral wall 29 converging radially as it approaches the outlet opening 28.

Advantageously but not necessarily, the combustion chamber 22 is provided with one or more supply channels 30 for the oxidizer OX, configured to convey a part OX” of the oxidizer OX into the combustion chamber 22 generating, together with the oxidizer-fuel mixture M′, an oxidizer-fuel mixture M″.

In particular, the supply channels 30 for the oxidizer OX are produced in such a way that the part OX” of the oxidizer OX enters the inside of the combustion chamber 22 with a speed at least partially transverse with respect to a main direction of the oxidizer-fuel mixture M′ substantially corresponding to the longitudinal axis AA of the burner.

According to the non-limiting embodiment of FIG. 8, the lateral wall 29 of the combustion chamber 22 has a substantially frusto-conical shape comprising a larger base 31 and a smaller base 32, in which the larger base 31 is arranged at the inlet opening 27, while the smaller base 32 is arranged at the outlet opening 28.

Advantageously but not necessarily, the supply channels 30 for the oxidizer OX are made so as to allow the part OX” of the oxidizer OX to enter the combustion chamber 22 with a speed having a direction substantially parallel to the lateral wall 29 of the second combustion chamber.

In the non-limiting embodiment of FIGS. 4 to 10, the burner 1 comprising a combustion chamber 33 is arranged downstream of the combustion chamber 22 and provided with an inlet opening 34 and an outlet opening 35 opposite to each other. The inlet opening 34 is configured to be communicating with the outlet opening 28 and to receive the oxidizer-fuel mixture M″. In particular, the outlet opening 35 faces the tubular discharge element 18 (or the firing chamber 3). More precisely, the combustion chamber 33 comprises a lateral wall 36 having a substantially circular transverse section, in particular cylindrical (or constant parallel to the longitudinal axis AA of the burner 1), and provided with one or more supply channels 37 for the oxidizer OX configured to allow the inlet of a part OX”’ of the oxidizer OX into the combustion chamber 33, generating, together with the oxidizer-fuel mixture M″, an oxidizer-fuel mixture M‴, which is generated inside the combustion chamber 33 and is conveyed towards the tubular discharge element 18 (or towards the firing chamber 3).

Advantageously but not necessarily, and as illustrated in the non-limiting embodiments of FIGS. 1 to 5, the suction element 19 is adapted to (configured to) be arranged, at least partially (in some cases totally) inside the firing chamber 3.

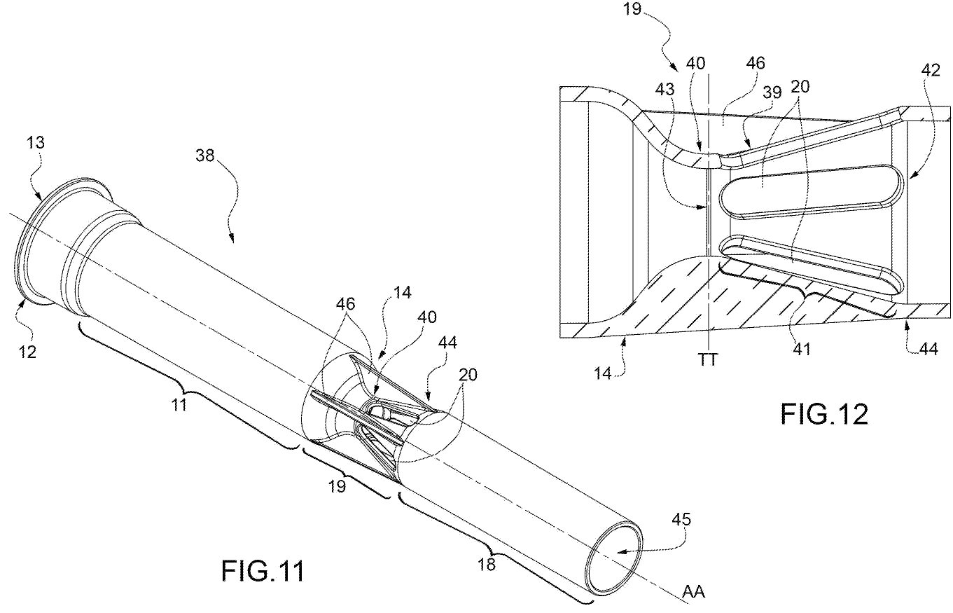

In the non-limiting embodiments of FIGS. 4, 5, 11 and 12, the tubular discharge element 11, the tubular discharge element 18 and the suction element 19 together form a combustion block 38 illustrated schematically overall in FIG. 11. In particular, a lateral surface 39 of the combustion block 38 is (at least) partially seamless. More in particular, the lateral surface 39 of the combustion block 38 is seamless in the sections not interrupted by the openings 20.

Advantageously but not necessarily, the combustion block 38 is manufactured in one single piece, in particular made of silicon carbide. More precisely, the longitudinal axis of symmetry of the combustion block 38 is the longitudinal axis of symmetry AA of the burner 1, of the tubular discharge elements 11 and 18 and of the multi-stage combustion head 10.

Advantageously but not necessarily, the combustion block 38 is made by means of additive manufacturing, in particular 3D printing.

According to some non-limiting embodiments not illustrated, the combustion block 38 is formed by welding the tubular discharge element 11 with the suction element 19 and the suction element 19 with the tubular discharge element 18.

According to other non-limiting embodiments not illustrated, the combustion block 38 is formed by mechanical coupling by means of fastening systems (e.g., bolts, screws, rivets, etc.) of the tubular discharge element 11 with the suction element 19 and of the suction element 19 with the tubular discharge element 18.

According to further non-limiting embodiments, the combustion block 38 is formed by mould casting techniques.

In the non-limiting embodiments illustrated in the attached figures, the combustion block 38 is hollow and is adapted to (configured to) allow the passage of a mixture (in particular the mixture M‴) generated by the mixing body 5 (or by the combustion head 10). In particular, said mixture M′, M″, M‴, once the combustion has been triggered, becomes a flame.

According to some non-limiting embodiments, the suction element 19 comprises, in particular is, a Venturi tube.

In the non-limiting embodiment of FIGS. 11 and 12 (where FIG. 12 illustrates a detail of the suction element 19 of the embodiment of FIG. 11), the suction element 19 has a choke 40 arranged at the end 14.

Furthermore, the suction element 19 has at least one section 41 having frusto-conical shape, delimited by a larger base 42 and a smaller base 43. Lastly, the tubular discharge element 18 has an open end 44 facing the suction element 19 and an open end 45 facing the centre of the firing chamber 3.

Advantageously but not necessarily, the openings 20 have an elongated shape, or are slots, and cross from side to side (transversely) the frusto-conical section 41 of the suction element 19. In particular, the openings 20 are obtained longitudinally to the tubular discharge element 11 and to the tubular discharge element 18.

More in particular, the smaller base 43 of said frusto-conical section 41 coincides with the choke 40, and the larger base 42 of said frusto-conical section 41 coincides with the open end 44.

Advantageously but not necessarily, the openings 20 are provided on the frusto-conical section 41 of the suction element 19. In particular, they cross from side to side (transversely) the frusto-conical section 41 of the suction element 19.

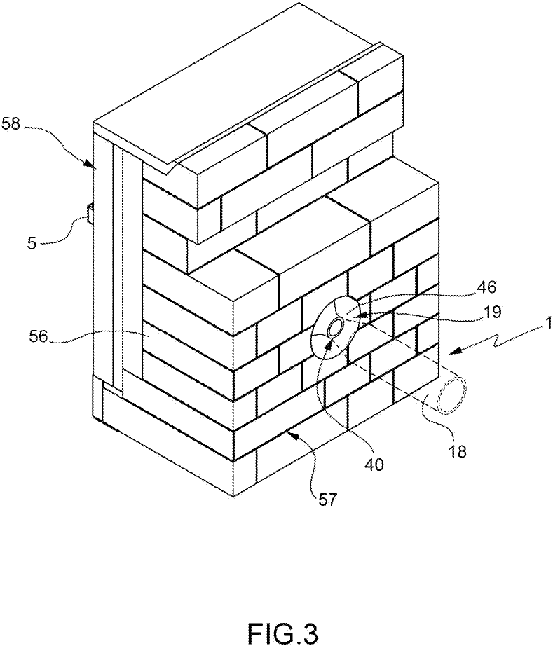

Advantageously but not necessarily, and as illustrated in FIGS. 3-5, 11 and 12, the suction element 19 comprises reinforcement ribs 46. Thanks to these ribs 46, it is possible to elongate the discharge element 18 as desired without risking breakage of the combustion block 38 at the segment with smaller section, or at the suction element 19.

Advantageously but not necessarily, the discharge element 11 has a circular cross-section, in particular with constant diameter.

Advantageously but not necessarily, the discharge element 18 has a circular cross-section, in particular with constant diameter.

Advantageously but not necessarily, the suction element 19 has a circular cross-section.

Advantageously but not necessarily, the suction element 19 has a circular cross-section with substantially variable diameter.

In particular, the cross-section TT (FIG. 12) of the choke 40 has a diameter smaller than two thirds of the diameter of the discharge element 18 and of the diameter of the discharge element 11. More in particular, the cross-section TT (FIG. 12) of the choke 40 has a diameter smaller than half of the diameter of the discharge element 18 and of the diameter of the discharge element 11. The more the diameter of the choke 40 is reduced with respect to the diameter of the discharge element 11, the greater the increase in the speed variation of the mixture M‴ which, in use, circulates inside the discharge element 11.

Advantageously but not necessarily, the cross-section TT (FIG. 12) of the choke 40 has a diameter smaller than a third of the diameter of the discharge element 18 and of the diameter of the discharge element 11. In particular, the cross-section TT (FIG. 12) of the choke 40 has a diameter greater than one sixth of the diameter of the discharge element 18 and of the diameter of the discharge element 11.

Advantageously but not necessarily, the diameter of the choke 40 is smaller than 30 mm, in particular equal to or smaller than 25 mm. In detail, the diameter of the choke 40 ranges from 5 mm (in particular 10 mm; more in particular 20 mm) to 60 mm (in particular 40 mm; more in particular 30 mm). Also this characteristic counters the backfire and therefore improves management of the combustion with hydrogen-rich mixtures of fuel FL.

Advantageously but not necessarily, the diameter of the discharge element 11 and the diameter of the discharge element 18 range from 20 mm (in particular 40 mm; more in particular 50 mm) to 200 mm (in particular 120 mm; more in particular 100 mm).

In some non-limiting cases, the trigger device 8 and/or the flame detection device 9 have an elongated shape and are inserted inside the mixing body 5 along an electrode channel 47 and an electrode channel 48 respectively arranged along the axes AI and AR respectively (illustrated in FIG. 8) at least partially inclined (for example by at least 5° or 10°) by an angle α and by an angle β respectively relative to the longitudinal axis AA of the burner 1. In some non-limiting cases, the angles α and β are substantially equal to each other. In other non-limiting cases, the angles α and β are different from each other.

In particular, the angles α and β are angles smaller than 45°. More in particular, the angles α and β are angles smaller than 30°. More precisely, the angles α and β are smaller than 20°. In detail, the angles α and β are substantially equal to 15°.

In the non-limiting embodiment of FIG. 8, the trigger device 8 comprises a trigger electrode 49 and the flame detection device 9 comprises a detection electrode 50. In particular, the detection electrode 50 is longer than (more precisely over twice as long as) the trigger electrode 49. Advantageously but not necessarily, the flame detection device 9 (more precisely the detection electrode 50) passes through at least the combustion chambers 21 and 22 and is configured to be arranged at least partially tangent to the flame dart (or to the shape of the flame when operating at full capacity). In this way, it is possible to preserve the integrity of the flame detection electrode 50. In effect, the fact that the detection electrode 50 remains tangent to the flame dart, without being immersed inside it, limits wear on the electrode. In particular, as illustrated in the non-limiting embodiment of FIG. 8, the flame detection device 9 (more precisely the detection electrode 50) also passes through the chamber 33 and terminates inside the tubular discharge element 11. In use, the detection electrode 50 provides data relative to the state of the flame generated by the burner, via which it is possible to appropriately adjust the flow rate of the fuel FL and/or the oxidizer OX.

According to a preferred but non-limiting embodiment, as illustrated in FIGS. 4a, 5a and 8a, the trigger device 8 comprises a trigger electrode 43 and the flame detection device 9 comprises a UV detection probe 50′. In particular, the UV probe 50′ is arranged along the longitudinal axis AA of the burner on board a breech 54, more precisely but without limitation, on board the mixing body 5.

Advantageously but not necessarily, the flame detection device 9 (more precisely the UV detection probe 50′) is configured so as to receive a UV (ultraviolet radiation) beam coming from the flame which passes through at least the combustion chambers 21 and 22. In use, the UV detection probe 50′ provides data relative to the state of the flame generated by the burner, via which it is possible to appropriately adjust the flow rate of the fuel FL and/or of the oxidizer OX. Furthermore, in the case of flameless combustion, at full operating capacity the UV probe 50′ is disabled because it is no longer able to detect any flame, since the flame front is diluted inside the kiln firing chamber.

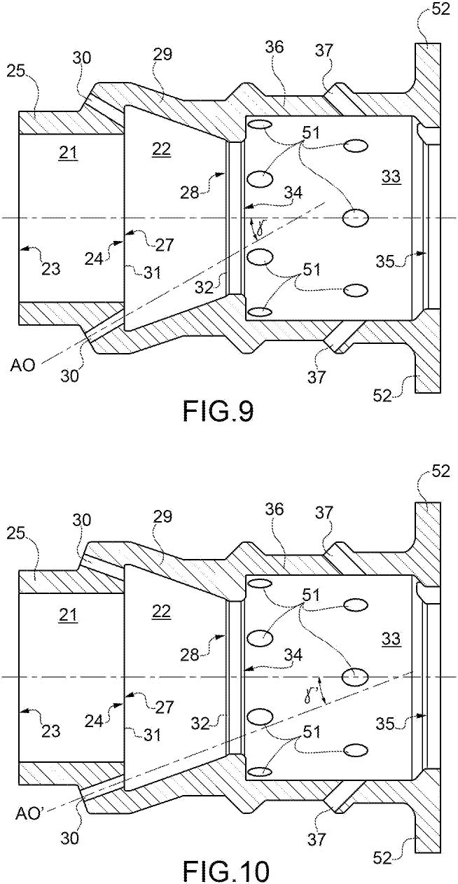

In the non-limiting embodiments of FIGS. 9 and 10 two possible variations of the combustion head 10 are illustrated in front section, in which the oxidizer supply channels 30 have different inclinations from each other. In particular, in FIG. 9, an inclination axis AO of the channels 30 is inclined by an angle γ substantially equal to 30°, whereas in FIG. 10 the inclination axis AO’ of the channels 30 is inclined by an angle γ′ substantially equal to 20°. In this case, the lateral wall 29 of the combustion chamber 22 and the supply channels 30 of the oxidizer OX are substantially parallel. The above can obviously also be applied to the supply channels 37 of the oxidizer OX.

Advantageously but not necessarily, the combustion chamber 33 comprises, on the lateral wall 36, a plurality of holes 51 arranged in one or more radial rows, preferably at the same radial distance from one another.

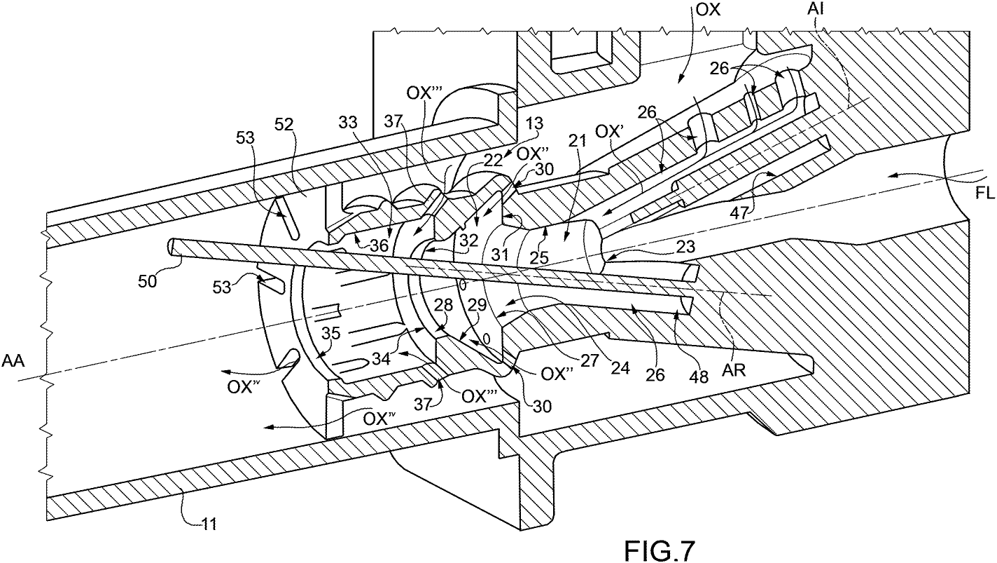

In the non-limiting embodiment of FIG. 7, the combustion head 33 comprises a crown 52 configured to limit entry of the oxidizer OX into the tubular discharge element 11 which does not pass through the combustion chambers 21, 22 and 33. In particular, the crown 52 extends from the edge of the outlet opening 35 towards (to) the inner wall of the tubular discharge element 11.

Advantageously but not necessarily, and as illustrated in the non-limiting embodiment of FIG. 7, the crown 52 comprises slots 53 (or any other type of opening) configured to convey a second part OXIV of the oxidizer into the tubular discharge element 11 downstream of the combustion chambers 21, 22 and 33. In this way, together with the oxidizer-fuel mixture M‴, the fluid F is generated flowing out of the tubular discharge element 11, through the suction element 19 towards the tubular discharge 18.

In accordance with a second aspect of the present invention, an industrial apparatus is provided for the firing of ceramic articles.

With particular reference to FIGS. 1 and 2, an industrial apparatus in accordance with the present invention is indicated overall by the number 55.

According to some non-limiting embodiments, the ceramic articles T, once fired, are tiles.

In particular, the ceramic articles T are green at the inlet of the apparatus 55 and fired at the outlet.

The industrial apparatus 55 comprises the kiln 2 (described above), in particular a tunnel kiln, provided with at least one lateral wall 56 which delimits the firing chamber 3 and has a surface 57 inside the firing chamber 3 and a surface 58 outside the firing chamber 3.

The industrial apparatus 55 further comprises the transport system 4, in particular horizontal, which is configured to move the plurality of ceramic articles T along the conveying path P inside the firing chamber 3 (from the inlet to the outlet of the firing chamber 3).

The transport system 4 can be any type of transport system. For example, the transport system 4 comprises a conveyor belt (or a conveyor mesh) on which the green ceramic articles T to be fired are arranged, preferably in an orderly fashion.

According to some non-limiting embodiments not illustrated, the transport system 4 comprises a plurality of ceramic rollers (if necessary, moved at different speeds to differentiate firing of the articles).

In particular, the tunnel kiln 2 has two opposite lateral walls 56, between which the ceramic articles T travel.

According to some non-limiting embodiments not illustrated, the ceramic articles are any type of ceramic article requiring at least one firing in the kiln.

The apparatus 55 comprises a burner 1 which, in turn, comprises a tubular discharge element 11, and preferably but not necessarily a tubular discharge element 18 and a suction element 19 for the gases G, G′.

Advantageously but not necessarily, the apparatus 30 comprises a (hydrogen) burner 1 as previously described.

Advantageously but not necessarily, the apparatus 55 comprises a hydrogen supply system configured to inject hydrogen or a mixture comprising hydrogen into the supply duct 6 for the fuel FL.

Advantageously but not necessarily, the suction element 19 is located between the discharge element 11 and the discharge element 18 and is arranged at least partially (in some non-limiting cases also totally, as illustrated in FIG. 5) inside the firing chamber 3.

In particular, the suction element 19 is configured to bring at least part of the gases G, G′ present inside the firing chamber 3 into the discharge element 18. In this way, it is possible to use the residual oxygen inside the firing chamber 3 and complete the combustion of the gases G, G′ that have not been fully combusted during their first passage inside the burner 1, or by primary combustion.

In addition, the gases G, G′ (presumably, also in view of the fact that they have a relatively high temperature) help to improve the combustion efficiency.

The term “primary combustion” indicates the combustion generated by the mixing body 5 (in particular by the combustion head 10), the flame of which passes through the discharge element 11.

Advantageously but not necessarily, and as illustrated in the non-limiting embodiment of FIG. 4, the suction element 19 is arranged at the inner surface 57 of one of the lateral walls 56.

In particular, the suction element 19 is configured to create a depression between the discharge element 11 and the discharge element 18 so as to bring at least part of the gases G, G′ present in the firing chamber 3 into the discharge element 18. In other words, in the non-limiting embodiments illustrated in the attached figures, the depression is generated by Venturi effect.

The high flame speed generated by the multi-stage combustion head 10 has the surprising synergic effect of increasing the suction capacity of the suction element 19.

According to some non-limiting embodiments not illustrated, the burner comprises several tubular discharge elements 18 inside the firing chamber 3, with several suction elements 19 positioned between them at intervals.

According to the non-limiting embodiment of FIG. 2, the apparatus 55 comprises a plurality of burners 1 arranged in series along a direction DD parallel to the conveying path P. In particular, the burners 1 are arranged on several levels inside at least one of the walls 56 of the kiln 2.

In the non-limiting embodiments of FIGS. 1 to 5, the burner 1 is coupled, by means of fastening elements, to the wall 56 of the kiln 2. In particular, the discharge element 11 is inserted inside the wall 56.

In the non-limiting embodiment of FIG. 1, the burners 1 are oriented in a direction DP transverse (in particular, perpendicular) to the direction DD (and therefore to the conveying path P).

Advantageously but not necessarily, the tubular element 11 of the burner 1 is installed so as to pass through, at least partially (in particular totally and transversely), one of the lateral walls 56 of the kiln 2. In this way the flame produced by the burner 1 will flow directly towards the inside of the firing chamber 3 of the kiln 2.

According to the non-limiting embodiments illustrated in the attached figures, the burner 1 has a longitudinal axis AA which is transverse to the conveying path P. In particular, the axis AA is perpendicular to the conveying path P. More in particular, the axis AA is perpendicular also to the lateral wall 56 of the industrial tunnel kiln 2.

Advantageously but not necessarily, the tubular discharge element 18 of the burner 1 is coaxial with respect to the tubular discharge element 11 and is substantially completely arranged inside the firing chamber 3.

According to some non-limiting embodiments not illustrated, the discharge element 11 of the burner 1 is installed so as to partially protrude inside the firing chamber 3.

Advantageously but not necessarily, the openings 20 are arranged at least partially (in particular totally) inside the firing chamber 3.

Advantageously but not necessarily, the apparatus 55 (or each burner 1) comprises at least one electronic control unit 62 configured to control the burner 1 so as to pass from a firing configuration with flame to a flameless firing configuration. In particular, the electronic control unit 62 is configured to extinguish the flame by reducing (preferably interrupting) the supply of the fuel FL and if necessary, of the oxidizer OX, selectively inhibit the flame control (by means of the detection device 9) and restore the supply of the fuel FL and if necessary, of the oxidizer OX allowing the burner 1 to fire in flameless mode. By using flameless combustion, or a combustion which exploits the fact that inside the kiln there is a temperature higher than the self-ignition temperature of the fuel, it is possible to drastically reduce the emissions of NOx normally generated in the combustion of hydrogen-rich mixtures (and in general combustions with high flame peaks), thus allowing the use of an environmentally sustainable fuel with low emissions.

Advantageously but not necessarily, and as illustrated in the non-limiting embodiment of FIG. 1, the apparatus comprises at least two temperature control devices 63, in particular at least two thermocouples 64 with double filament, arranged in at least two different “significant” points of the kiln 2. These two points are such as to ensure that at each point of the firing chamber the temperature is sufficiently higher than the self-ignition temperature of the combustible mixture.

Advantageously but not necessarily, if the temperature detected by the two thermocouples 64 drops below the self-ignition temperature, the flame is sparked and re-ignited, namely the electronic control unit 62 immediately restores the operating mode of the burner 1 with flame.

According to a further aspect of the present invention, a method is provided for the firing of ceramic articles conveyed inside a tunnel kiln.

The method comprises at least a step of supplying a burner as previously described with a fuel comprising at least a percentage of hydrogen higher than 20%, in particular higher than 50%, more in particular higher than 70%. These fuel mixtures are made possible by the particular geometry of the burner described above, in particular thanks to the multi-stage combustion head 10. Furthermore, the dimensions of the nozzle 17 (of the axial hole 59), the geometry of the distribution element, namely the dimension and number of through openings 61, and the tubular discharge element 18 and the suction element 19, synergically result in the important technical effect of reducing environmental impact, allowing the use of a hydrogen-rich mixture as fuel and lowering of the NOx.

In some non-limiting cases, the fuel FL comprises a hydrogen percentage higher than 90%. In particular, the fuel is 100% hydrogen.

The method further comprises the step of simultaneously supplying the burner 1 with the oxidizer OX and triggering (igniting) the flame (by means of the trigger device 8) which extends at least partially inside the burner and the firing chamber 3 of the kiln 2.

Once the flame has been ignited, the method entails controlling the flame in feedback by means of the detection device 9.

Advantageously but not necessarily, the method comprises the further steps, once the firing chamber 3 of the kiln 2 has reached a predefined temperature (in particular higher than the self-ignition temperature of the fuel FL), of extinguishing the flame by reducing (or interrupting) supply of the fuel FL and if necessary of the oxidizer OX; preferably disabling the above-mentioned flame feedback control; and restoring the supply of the fuel FL, in particular also of the oxidizer, generating inside the tunnel kiln 2 a flameless combustion which fires the ceramic articles T. In these non-limiting cases, this step represents firing of the kiln 2 at full capacity. In this latter step, in particular, the burner 1 is no longer mechanically ignited/triggered and there is no longer a flame (or rather, a flame front) present and located on the combustion head 10 and inside the tubular discharge element 11, because it is diluted directly in the kiln chamber with the combustion products already present in the chamber 3 with an oxygen level lower than that of the comburent air. In other words, in this way, the oxidizer/fuel mixture flowing out of the burner 1 towards the firing chamber 3 is ignited inside the chamber 3.

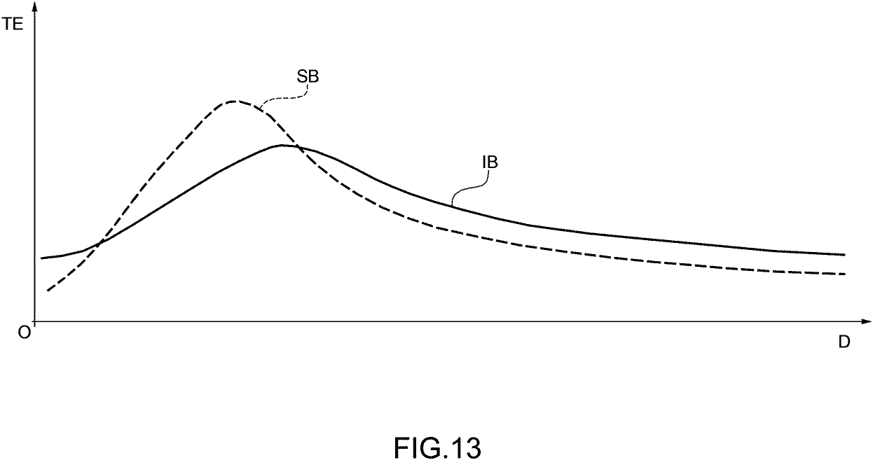

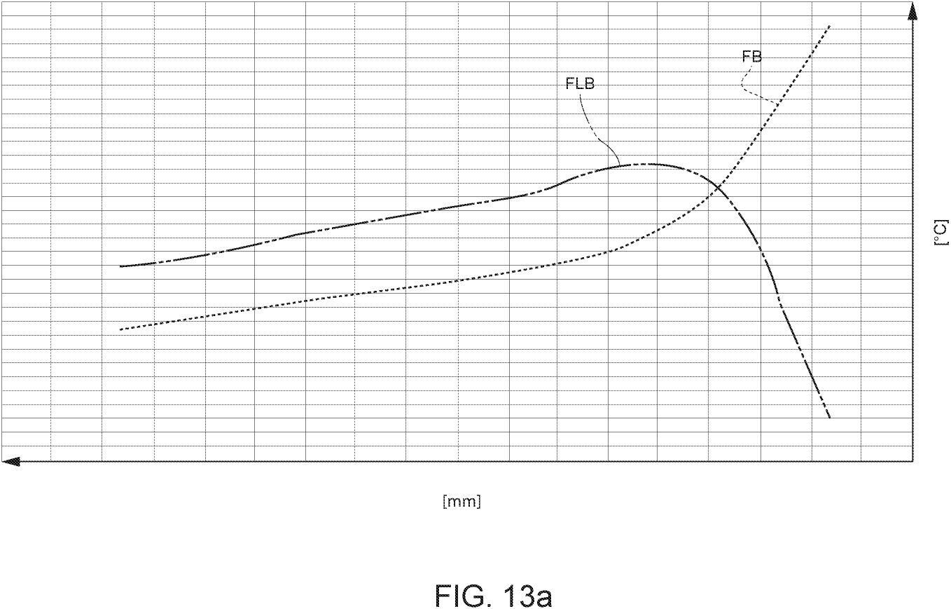

In this way, it is possible (as illustrated in the non-limiting embodiment of FIG. 13a, which illustrates temperature profiles FB with flame and FLB without flame as the distance from the lateral wall 56 of the kiln 2 increases) to avoid the presence of temperature peaks (which are one of the main causes of the production of NOx) with respect to the traditional solutions with flame. In particular, in FIG. 13a it can be seen from the profile FB that the temperatures obtained from combustion with flame in the immediate vicinity of the discharge are extremely high (around 1500° C. near the discharge and even 1600° C.-1800° C. inside the combustion block 38). On the other hand, in the flameless configuration, peak temperatures of approximately 1250° have been recorded inside the firing chamber 3 of the kiln 4, whereas inside the burner 1 there are only a few hundred degrees since no combustion is present. This entails in turn a lower thermal load on the components of the burner 1 (for example on the combustion head 10, on the mixing body 5, on the combustion block 38, on the oxidizer and fuel pipes, etc.). At the same time, a significant reduction in heat loss caused by the burner is obtained, thus improving the efficiency of the kiln 2.

In the absence of a flame, furthermore, the burner 1 will be more silent, thus also reducing the noise pollution produced by the latter.

In addition, due to the lower compression inside the combustion block 38, the power that can be delivered by the single burner increases.

Lastly, the higher speed reached to counter the backfire increased by the hydrogen allows greater penetration of the fumes flowing out of the burner 1 inside the firing chamber 3, which results in greater uniformity in firing of the articles T.

In use, the trigger device 8 (in particular the trigger electrode) generates a spark which together with the fuel FL flowing in from the duct 6 and the oxidizer OX flowing in from the duct 7 causes generation of the flame. In particular, the part OX′ of the oxidizer and fuel FL generate the mixture M′ inside the combustion chamber 21, which defines a first stage of the flame and continues towards the combustion chamber 22, inside which the mixture M′ and the part OX” of the oxidizer form the mixture M″, which defines a second stage of the flame. The mixture M″ in combustion is conveyed towards the combustion chamber 33, inside which the mixture M″ and the part OX’” of the oxidizer are combined (in particular together with a further part of oxidizer flowing in from the holes 51) to form the mixture M‴, which in turn flows out of the combustion chamber 33 into the tubular discharge element 11 in which, mixing with the part OXIV of the oxidizer OX, it forms the fluid F. Therefore, the mixing body 5 generates an at least partially combusted mixture, or a flame, the fluids F of which travel through the discharge element 11, which introduces them into the suction element 19, which in turn conveys them (together with the gases G, G′ extracted from the inside of the firing chamber 3) into the discharge element 18. The latter introduces the flame into the combustion chamber.

The combustion products emitted by the burner 1 are not totally combusted during their first passage through the discharge element 11, but the combustion is increased (completed) due to continuous recirculation of the gases G, G′ (present inside the firing chamber 3) through the suction element 19 into the discharge element 18.

In other words, the burner 1 generates, via the trigger device 8, a primary combustion on the gases flowing in from the ducts 6 and 7 (fuel and oxidizer) and a secondary combustion thereof by exploiting the gases G, G′ recirculated from the inside of the firing chamber 3 and not completely combusted (in which residual oxygen is present) extracted by the suction element 19. In particular, the primary combustion takes place inside the discharge element 11 and the secondary combustion takes place inside the discharge element 18.

In particular, the combined action of the choke 40 and the multi-stage combustion head 10 (which allows a good combustion percentage to be obtained in less time due to pre-mixing inside the combustion chambers 21, 22 and 33) determine an increase in the speed of the fluid F emitted from the burner 1 flowing out of the discharge element 11. Subsequently, the speed of the gas drops again due to the tapered, in particular diverging, shape of the frusto-conical section 41. In detail, the use of a multi-stage combustion head 10 allows the choke 40 to be further narrowed determining an even greater depression.

It has been hypothesized that the speed variation of the fluid F, exploiting the Venturi effect, causes a depression at the openings 20. This depression causes, in turn, suction of the gases G, G′ present inside the chamber 3 and therefore allows a secondary combustion exploiting said gases G, G′ (in which a fair percentage of oxygen is still present -approximately 10%).

In the non-limiting embodiments illustrated in the attached figures, the suction element 19 (due to the high speed of the fluid F generated by the multi-stage combustion head 10) causes an increase in the turbulent motion inside the firing chamber 3. Furthermore, the secondary combustion that takes place inside the discharge element 18 generates a further increase in heat exchange, in particular by radiation, due to heating of the discharge element 18. This results in an increase in the overall heat exchange coefficient on the ceramic articles T and a greater temperature uniformity inside the firing chamber 3.

According to the advantageous non-limiting embodiment illustrated in FIGS. 3 and 4, the choke 40 of the suction element 19 is arranged at the level of the inner surface 57 of the wall 56 of the kiln 2. This characteristic allows maximization of the suction and recirculation of the gases G′ present near the inner surface 57 of the wall 56 of the kiln 2, which are the gases with lowest turbulence and therefore lowest temperature.

The graph in FIG. 13 illustrates the temperature trend according to the distance from the wall 56 of the kiln 2; this graph has been obtained experimentally. In particular, the Y axis indicates the temperature of the ceramic articles T in firing and the X axis the distance from the wall 56. The temperature variation indicated by the broken line SB refers to an apparatus with a standard burner, while the temperature variation indicated by the continuous line IB refers to a non-limiting embodiment of the apparatus 55 in accordance with the present invention.

It is therefore evident that, by using an apparatus 55 or a set of burners 1 in accordance with the present invention, a greater temperature uniformity is obtained along the width of the firing chamber 3 of the kiln 2. In particular, the temperature in the vicinity of the wall 56 is considerably increased due to the turbulence generated by the suction element 19 (thanks to the higher speed allowed by the multi-stage combustion head 10) and the contribution of the radiation provided by the discharge element 18 in the vicinity of said wall 56. Furthermore, the temperature in the centre of the kiln is increased with respect to the traditional case due to use of the discharge element 18, which allows the combustion block 38 to reach great depths inside the kiln 2. Therefore, the flame coming out of said discharge element 14 is emitted at a greater depth than in the traditional solutions.

It is important to note that also the temperature peak in the vicinity of the discharge of the burner 1 is (at least partially) flattened.

Although the invention described above refers in particular to a precise implementation example, it should not be considered limited to said implementation example, since all variations, modifications or simplifications covered by the attached claims fall within its scope, such as, for example, a different geometry of the combustion head 10, of the combustion block 38 and in particular of the suction element 19, a different suction method of the gases G′ in the vicinity of the inner surface 57 of the lateral wall 56, a different arrangement of the burners 1 inside the apparatus 55 (in terms of both position and alignment), a different transport system 4, etc.

The apparatus and the burner described above offer numerous advantages.

Firstly, production and assembly of the burner 1 are simplified compared to solutions of the known art comprising several components. In addition, the burner 1, given the geometry and penetration into the firing chamber 3, can very simply be installed to replace (as an improvement of) a standard architecture.

Furthermore, the presence of the discharge element 18 inside the chamber 3 and of the suction element 19 in the vicinity of the inner surface 57 of the wall 56 and not inside the wall 56 avoid problems connected with overheating of said wall 56, usually made of brickwork, which would entail overheating, with possible breakages, of the combustion block 38 and/or overheating of the mixing body 5 (usually made of metal), which in turn would generate a risk of burns for the operators and a non-negligible dispersion of energy. Furthermore, problems are avoided connected with the formation of deposits and obstructions that may be caused by condensation of recirculated gases inside the brickwork of the lateral wall 31.

Further advantages of the present invention are reduction of dispersions, increase in combustion (the recirculation obtained, at least 50% of the burner combustion products, allows the use of regulations with reduction of the oxidizer, exploiting the residual oxygen present in the recirculated gases G, G′) and temperature uniformity inside the firing chamber 3, and these determine, on the part of the apparatus 55 and the burner 1 in accordance with the present invention, the need for a lower quantity of gas (usually methane) to be introduced into the burner 1 to maintain a given temperature, with respect to the solutions of the known art.

Furthermore, the use of a multi-stage combustion head 10 allows reduction of the flame temperature peaks, which are the main cause of the creation of nitrogen oxides. Therefore, the present invention determines a reduction in nitrogen oxides (NOx), in particular below 50 ppm.

In addition, the synergic effect between the multi-stage combustion head 10 and the combustion block 38 allows for the use of very small discharges. In particular, in some non-limiting cases, the diameter of the choke is 25 mm. This is due to the high speed that can be obtained by means of the air staging technique, which allows a flame speed of approximately 200 m/s.

The present invention is configured to be supplied with different types of gas (for example methane or LPG) and is designed to function with environmentally sustainable fuels such as, for example, hydrogen-enriched methane, pure hydrogen, etc. In particular, the shape of the oxidizer supply channels varies depending on the fuel used.

Compared to a traditional burner, the flame of the burner in accordance with the present invention is more uniform and less swirled.

This characteristic allows the flame to remain neat and to propagate more without opening too much in the surrounding environment (or in the firing chamber 3). This means that the ceramic articles in transit during the firing are affected very little by direct interaction of the flame, therefore avoiding possible technological defects (colour shading, different sizes, etc.) due to the temperature peaks often determined by direct interaction with the flame.

Furthermore, the high recirculation created by the very high flame speed of the burner 1, comprising a combustion block as described above, dilutes the flame temperatures (or diminishes the peaks, increasing the median) and increases the coefficient of convective exchange with the ceramic articles T. For this reason, with respect to a traditional architecture and with the same power, the present invention allows greater heating of the material without “attacking” it with flame temperature peaks, oxidizing in a more uniform manner the organic substances contained in the ceramic articles T and therefore avoiding the appearance of a darker colouring on the internal portion of an article when seen in section.

In this way, the risk of explosion of the ceramic articles T in a pre-heating area of the kiln 2, for example when articles with an excessive humidity content are placed in the kiln, is also partially inhibited.

In addition, due to the high recirculation of gas generated, the combustion products tend to stratify horizontally, without creating vertical motions from a lower chamber of the kiln towards an upper chamber in the vicinity of the walls. For this reason, the occurrence of imperfections (small cracks) on lateral edges of the articles adjacent to the lateral walls 56 of the kiln 2, especially in the pre-heating areas, is at least partially inhibited.

Since the burner 1 maintains a high flame speed also at low working capacity (for example in the case of production gaps), also the crown of the kiln 2 is not (substantially) thermally stressed by the direct interaction of the flame. Consequently, the apparatus 55 in accordance with the present invention also allows greater firing uniformity of the ceramic articles, especially in “wide mouth” kilns. This characteristic determines the further advantage of being able to reduce the height of the chamber 3 of the kiln 2, so as to further increase the exchange between the gases G and the ceramic articles T in firing without risking damage to the crown of the kiln or the articles themselves due to undesired flame plumes.

Lastly, the reduction of the kiln chamber results in the following advantages: reduction of the volumes inside the chamber, therefore improved convective thermal exchange with the material and consequent reduction of specific consumption.

1-31. are (canceled)

32. A burner for the firing of ceramic articles (T), which can be installed in an industrial kiln comprising a firing chamber, the burner comprising:
a mixing body;
at least one duct to supply a fuel (FL);
at least one duct to supply an oxidizer (OX);
a trigger device to start a combustion;
a flame detection device;
a first tubular discharge element, which is configured to be passed through by a fluid (F) flowing out of the mixing body and is provided with a first end, inside which at least part of the mixing body is inserted, and a second end opposite the first end;
wherein the burner also comprises:
at least one second tubular discharge element, which extends from the second end on the opposite side with respect to the first end, and
a suction element, which is configured to bring at least part of the gases (G, G′) present outside the burner into the second tubular discharge element and is provided with one or more openings arranged between the first and the second tubular discharge elements;
the mixing body comprising a multistage combustion head arranged at least partially inside the first tubular discharge element.

33. The burner according to claim 32, wherein:
the multistage combustion head comprises at least one first combustion chamber, configured to generate a first combustion phase of a flame, and at least one second combustion chamber, communicating with the first combustion chamber and configured to generate a second combustion phase of the flame coming out of the first combustion chamber;
the first and second combustion chambers are configured to convey the flame at high speed inside the first tubular discharge element and, passing through the suction element, towards the second tubular discharge element.

34. The burner according to claim 32, wherein:
the first combustion chamber comprises a first inlet opening and a first outlet opening;
the first inlet opening is configured to be communicating with the duct to supply the fuel and to receive a volumetric flow rate, in particular variable, of said fuel (FL);
the first outlet opening faces the second tubular discharge element;
the first combustion chamber also comprises a first lateral wall, in particular cylindrical, provided with one or more first oxidizer (OX) supply channels, which are configured to convey a first part (OX′) of the oxidizer (OX) inside the first combustion chamber generating a first oxidizer(OX)-fuel mixture (M′);
in particular, the first combustion chamber and the second combustion chamber are coaxial with each other and arranged along a longitudinal axis (AA) of the burner;
in particular, the first oxidizer (OX) supply channels are configured to convey the first part (OX′) of the oxidizer (OX) in correspondence to the trigger device.

35. The burner according to claim 33, wherein:
the second combustion chamber comprises a second inlet opening and a second outlet opening;
the second inlet opening is configured to communicate with the first outlet opening and to receive the first oxidizer-fuel mixture (M′);
the second outlet opening facing the second tubular discharge element;
the second combustion chamber also comprising a second lateral wall having a substantially circular cross-section, in particular converging radially towards the second outlet opening;
the second combustion chamber being provided with one or more second oxidizer (OX) supply channels, which are configured to convey a second part (OX″) of the oxidizer (OX) inside the second combustion chamber generating, together with the first oxidizer-fuel mixture (M′), a second oxidizer-fuel mixture (M″);
in particular, the second oxidizer (OX) supply channels are made in such a way as to allow the second part (OX″) of the oxidizer (OX) to enter the second combustion chamber with a speed having at least one tangential component with respect to a main direction of the first oxidizer-fuel mixture (M′), or with respect to a longitudinal axis (AA) of the burner.

36. The burner according to claim 35, wherein:
the second lateral wall of the second combustion chamber has a frusto-conical shape comprising a larger base and a smaller base;
the larger base at the second inlet opening, while the smaller base is arranged at the second outlet opening;
in particular, the second oxidizer (OX) supply channels are made in such a way as to allow the second part (OX″) of the oxidizer (OX) to enter the second combustion chamber with a speed substantially parallel to the second lateral wall of the second combustion chamber.

37. The burner according to claim 33, further comprising:
a third combustion chamber located downstream of the second combustion chamber and provided with a third inlet opening and a third outlet opening;
wherein:
the third inlet opening is configured to be communicating with the second outlet opening and to receive the second oxidizer-fuel mixture (M″);
the third outlet opening facing the second tubular discharge element;
the third combustion chamber comprises a third lateral wall having a substantially circular cross-section, in particular cylindrical, and provided with one or more third oxidizer (OX) supply channels, which are configured to allow a third part (OX‴) of the oxidizer (OX) to enter the third combustion chamber generating, together with the second oxidizer-fuel mixture (M″), a third oxidizer-fuel mixture (M‴), which is conveyed towards the second tubular discharge element.

38. The burner according to claim 32, wherein the suction element is configured to be arranged, at least partially, inside the firing chamber.

39. The burner according to claim 32, wherein the first tubular discharge element is coaxial with the second tubular discharge element and with the multistage combustion head;
in particular, the first tubular discharge element, the second tubular discharge element and the suction element form a combustion block, which has a lateral surface at least partially seamless.

40. The burner according to claim 32, wherein the first tubular discharge element, the second tubular discharge element and the suction element form a combustion block manufactured as one single piece, in particular made of silicon carbide;
the combustion block being coupled to the mixing body.

41. The burner according to claim 32, wherein:
the suction element has a choke arranged at the second end;
the suction element has at least one frusto-conical shaped section, which is delimited by a larger base and a smaller base;
the second tubular discharge element has a first open end, facing the suction element, and a second open end facing the inside of the firing chamber.

42. The burner according to claim 41, wherein the openings extend through the suction element (for example, they have an elongated shape and are arranged longitudinally to the first tubular discharge element and to the second tubular discharge element;
the smaller base of the frusto-conical shaped section coincides with the choke;
the larger base of the frusto-conical shaped section coincides with the first open end;
in particular, the openings are arranged on the frusto-conical shaped section.

43. The burner according to claim 32, wherein:
the trigger device and/or the flame detection device have an elongated shape and are inserted inside the mixing body respectively along a first channel and a second channel arranged along the axes (AI, AR) at least partially inclined with respect to a longitudinal axis (AA) of the burner;
in particular the flame detection device passes through at least one first combustion chamber and one second combustion chamber and is configured to be arranged at least partially tangent to a flame dart.

44. An industrial apparatus for the firing of ceramic articles (T) comprising:
a tunnel kiln provided with at least one lateral wall, which at least partially delimits a firing chamber and has an inner surface on the inside of the firing chamber and an outer surface on the outside the firing chamber;
a transport system, which is configured to move a plurality of ceramic articles (T) along a conveying path (P) inside the firing chamber;
wherein:
the kiln comprises at least one burner according to claim 32;
the suction element is arranged between the first tubular discharge element and the second tubular discharge element and is, at least partially, arranged inside the firing chamber;
the suction element is configured to bring at least part of the gases (G, G′) present in the firing chamber into the second tubular discharge element.

45. The apparatus according to claim 44, wherein:
the suction element is arranged at the inner surface of the lateral wall;
the suction element is configured to create a depression between the first discharge element and the second discharge element so as to bring at least part of the gases (G, G′) present in the firing chamber into the second discharge element;
in particular, the apparatus comprises a plurality of burners arranged in series along a direction (DD) which is parallel to the conveying path (P);
in particular, said burner has a longitudinal axis (AA) which is transverse (in particular, perpendicular) to the conveying path (P), for example perpendicular to said wall of the industrial kiln.

46. The apparatus according to claim 44, wherein:
the first tubular discharge element of the at least one burner at least partially (in particular, totally) extends through (in particular, transversely to) the lateral wall of the kiln;
the second tubular discharge element of the burner being substantially coaxial with respect to the first tubular discharge element and being substantially completely arranged inside the firing chamber.

47. The apparatus according to any one of claims 44, wherein the first tubular discharge element of the at least one burner is installed so as to partially protrude into the firing chamber.

48. A burner for the firing of ceramic articles (T), which can be installed in an industrial kiln comprising a firing chamber, the burner comprising:
a mixing body;
at least one duct to supply a fuel (FL) comprising a percentage of hydrogen;
at least one duct to supply an oxidizer (OX);
a trigger device to start a combustion;
a flame detection device;
a first tubular discharge element, which is configured to be passed through by a fluid (F) flowing out of the mixing body and is provided with a first end, inside which at least part of the mixing body is inserted, and a second end, which is opposite the first end;
wherein the mixing body of the burner comprises a multi-stage combustion head, which is arranged at least partially inside the first tubular discharge element;
wherein the multi-stage combustion head comprises at least one first combustion chamber, which is configured to generate a first phase of combustion of a flame, and at least one second combustion chamber, communicating with the first combustion chamber and is configured to generate a second phase of combustion of the flame coming out of the first combustion chamber;
the first and the second combustion chambers being configured to convey the flame inside the first tubular discharge element towards the second end.

49. The burner according to claim 48, wherein the fuel supply duct comprises a nozzle for introduction of the fuel towards the first combustion chamber, said nozzle having an axial hole with a diameter smaller than 20 mm, in particular smaller than 15 mm, more in particular smaller than or equal to 13.5 mm.

50. The burner according to claim 49, wherein the fuel introduction nozzle is obtained on a breech of the burner as one single piece together with the latter.

51. The burner according to claim 48, wherein:
an oxidizer distribution element is arranged along the oxidizer supply duct, towards the first combustion chamber, the element is provided with a plurality of through openings to split the oxidizer flowing into the first combustion chamber; and
said openings have a width which is smaller than 5 mm, in particular smaller than 4 mm, preferably smaller than or equal to 3.5 mm.

52. The burner according to claim 51, wherein the distribution element comprises at least three, in particular at least four through openings;
in particular, said openings are circular holes.

53. The burner according to claim 48, wherein the flame detection device comprises a UV probe, in particular arranged along a longitudinal axis of the burner on board a breech of the mixing body.

54. The burner according to claim 48, wherein:
the first tubular discharge element has a choke arranged at the second end;
the choke allowing the second end to have a diameter which is smaller than 30 mm, in particular equal to or smaller than 25 mm.

55. The burner according to claim 48, further comprising:
at least one second tubular discharge element, which extends from the second end on the opposite side relative to the first end; and
a suction element, which is configured to bring at least part of the gases (G, G′) present on the outside of the burner into the second tubular discharge element and is provided with one or more openings arranged between the first and the second tubular discharge elements.

56. The burner according to claim 48, further comprising:
a third combustion chamber, which is arranged downstream of the second combustion chamber and is provided with a third inlet opening and a third outlet opening;
wherein:
the third inlet opening is configured to communicate with the second outlet opening and to receive the second fuel-oxidizer mixture (M″); and
the third outlet opening faces the second tubular discharge element.

57. An industrial apparatus for the firing of ceramic articles (T) comprising:
a tunnel kiln provided with at least one lateral wall, which at least partially delimits a firing chamber and has an inner surface on the inside of the firing chamber and an outer surface on the outside of the firing chamber;
a transport system, which is configured to move a plurality of ceramic articles (T) along a conveying path (P) inside the firing chamber;
wherein the apparatus comprises at least one burner according to claim 48;
the industrial apparatus comprises at least one hydrogen supply system, which is configured to inject hydrogen or a mixture comprising hydrogen into the fuel supply duct.

58. The apparatus according to claim 57, wherein:
a suction element is arranged between the first tubular discharge element and a second tubular discharge element and, at least partially, inside the firing chamber;
the suction element is configured to bring at least part of the gases (G, G′) present in the firing chamber into the second discharge element;
in particular, the suction element is arranged at the inner surface of the lateral wall;
the suction element is configured to create a depression between the first discharge element and the second discharge element so as to bring at least part of the gases (G, G′) present in the firing chamber into the second discharge element;
in particular, the apparatus comprises a plurality of burners arranged in series along a direction (DD), which is parallel to the conveying path (P);
in particular, said burner has a longitudinal axis (AA) transverse (in particular, perpendicular) to the conveying path (P), for example perpendicular to said wall of the industrial kiln.

59. The apparatus according to claim 57, further comprising:
at least one electronic control unit, which is configured to control the burner so as to pass from a firing configuration with flame to a flameless firing configuration;
in particular, the electronic control unit is configured to extinguish the flame by reducing the supply of fuel and, if necessary, of the oxidizer and to restore the supply of fuel and, if necessary, of the oxidizer allowing the burner to fire in flameless mode.

60. The apparatus according to claim 59, further comprising:
at least two temperature control devices, in particular thermocouples with double filament, arranged in at least two different points of the tunnel kiln.

61. A method for the firing of ceramic articles (T) conveyed inside a tunnel kiln and comprising the steps of:
supplying a burner, in particular according to claim 48, with a fuel comprising at least a percentage of hydrogen higher than 20%, in particular higher than 50%, more in particular higher than 70%;
simultaneously supplying said burner with an oxidizer and sparking a flame at least partially inside the burner and a firing chamber of the tunnel kiln;
controlling said flame in feedback.

62. The method according to claim 61, wherein, once the firing chamber of the kiln has reached a certain temperature, the method further comprises the steps of:
extinguishing the flame by reducing the supply of fuel and, in particular, of the oxidizer; and
restoring the supply of fuel and, in particular, of the oxidizer generating, inside the tunnel kiln, a flameless combustion which fires the ceramic articles.
